(19) United States
(12) Patent Application Publication
(10) Pub. No.: US 2026/0154921 A1
(43) Pub. Date: Jun. 4, 2026

(54) METHOD FOR ALIGNING THREE-DIMENSIONAL DIGITAL MODELS OF DENTITION

(71) Applicant: SHANGHAI EA MEDICAL INSTRUMENTS COMPANY LIMITED, Shanghai (CN)

(72) Inventors: Mingzheng WANG, Shanghai (CN); Yang FENG, Shanghai (CN)

(21) Appl. No.: 19/124,065

(22) PCT Filed: Oct. 26, 2023
(86) PCT No.: PCT/CN2023/126939

§ 371 Date: Apr. 24, 2025

(30) Foreign Application Priority Data
Oct. 26, 2022 (CN) 202211322049.X

(51) Int. Cl. G06T 19/20; A61C 7/00

(52) U.S. Cl. CPC G06T 19/20; A61C 7/002; G06T 2210/41; G06T 2219/2004

(57) ABSTRACT

A computer-implemented method for aligning three-dimensional digital models of a dentition includes: obtaining first and second three-dimensional digital models; performing tooth alignment between each pair of teeth in the first and second three-dimensional digital models; and performing dentition alignment between the first and second three-dimensional digital models based on a result of the tooth alignment and a weight assigned to the each pair of teeth. The first three-dimensional digital model represents the dentition in a current tooth arrangement of a patient. The second three-dimensional digital model represents the dentition in one of target tooth arrangements at a plurality of successive treatment steps. The weight is assigned according to at least treatment information of the each pair of teeth at a treatment step corresponding to the second three-dimensional digital model, and a result of the dentition alignment is used for verifying an effect of a tooth treatment.

### CROSS REFERENCE TO RELATED APPLICATIONS

The present disclosure is a national phase entry under 35 U.S.C. § 371 of International Application No. PCT/CN2023/126939 filed on Oct. 26, 2023, and claims priority of Chinese Patent Application No. 202211322049.X, filed with the China National Intellectual Property Administration (CNIPA) on Oct. 26, 2022, the entire content of which is incorporated herein by reference.

### TECHNICAL FIELD

The present application generally relates to a method for aligning three-dimensional digital models of a dentition.

### BACKGROUND

With the continuous development of computer science, dental professionals are increasingly relying on computer technology to improve the efficiency of dental treatment.

The three-dimensional digital model of the dentition is one of the most commonly used data in dental treatment. Typically, the three-dimensional digital model of the dentition can be obtained by intraoral scanning, or by scanning a physical model (e.g., a plaster model) or impression of the dentition.

In the process of orthodontic treatment using shell-style orthodontic appliances, patients are usually required to return for a follow-up visit at a specified time point so that dental professionals can confirm whether the patient's actual treatment outcome aligns with the treatment plan. Such confirmation is generally performed by comparing the three-dimensional digital model of the current patient's dentition with the three-dimensional digital model of the dentition in the target tooth arrangement at a corresponding treatment step.

To effectively compare two three-dimensional digital models of a dentition, the two three-dimensional digital models of the dentition must first be aligned and converted to the same coordinate system. At present, this is mainly achieved through manual alignment. However, the manual alignment has disadvantages such as low efficiency, poor consistency and difficult to control errors.

Therefore, it is necessary to provide a new method for aligning three-dimensional digital models of a dentition.

### SUMMARY

One aspect of the present application provides a computer-implemented method for aligning three-dimensional digital models of a dentition, including: obtaining first and second three-dimensional digital models, respectively representing the same dentition in different tooth arrangements; performing coarse alignment between each pair of teeth in the first and second three-dimensional digital models based on a local coordinate system of the each pair of teeth; performing fine alignment between the each pair of teeth after the coarse alignment using an ICP method; selecting a plurality of reference points for each tooth in the first three-dimensional digital model to obtain a first reference point set; based on a result of the fine alignment, projecting the reference points of each tooth in the first three-dimensional digital model onto a corresponding tooth in the second three-dimensional digital model to obtain a second reference point set, each reference point in the first reference point set and a corresponding reference point in the second reference point set forming a pair of reference points; and performing overall alignment between the first and second three-dimensional digital models based on the first and second reference point sets.

In some embodiments, the coarse alignment is performed according to an SVD method.

In some embodiments, the coarse alignment is performed for the each pair of teeth by: selecting a plurality of pairs of reference points in the local coordinate system of the each pair of teeth, each pair of reference points having same coordinate values, and performing the coarse alignment between the each pair of teeth based on the plurality of pairs of reference points.

In some embodiments, weights of point pairs on which the fine alignment is based are assigned according to at least one of following: (1) weights are assigned according to long axis coordinates of the local coordinate system: a point pair closer to an incisal edge or occlusal surface of the tooth has a higher weight, and a point pair closer to a gum line has a lower weight; (2) weights are assigned according to the point pairs sorted by distance: in each iteration, the point pairs are sorted from large to small by distance, and a point pair with a larger distance has a lower weight; or (3) weights are assigned according to a preset distance threshold: in each iteration, based on that a distance of a point pair exceeds the preset distance threshold, a weight of the point pair is reduced.

In some embodiments, the computer-implemented method for aligning three-dimensional digital models of the dentition further includes: calculating a confidence level of the fine alignment based on a proportion of point pairs that complete the alignment.

In some embodiments, in each of point pairs on which the fine alignment is based for the each pair of teeth, a first point is a vertex of a first tooth in the pair of teeth, and a second point is an intersection point of a ray from the first point along a normal direction and a surface of a second tooth in the pair of teeth.

In some embodiments, the overall alignment is performed according to an SVD method.

In some embodiments, the first three-dimensional digital model represents the dentition in a current tooth arrangement of a patient, and the second three-dimensional digital model represents the dentition in one of target tooth arrangements at a plurality of successive treatment steps.

In some embodiments, a weight of a reference point in the overall alignment is assigned according to at least one of following: (1) the weight is assigned according to a designed movement amount of a tooth corresponding to the reference point at a treatment step corresponding to the second three-dimensional digital model: the smaller the designed movement amount of the tooth is, the greater the weight is; (2) the weight is assigned according to the confidence level of the fine alignment for the tooth corresponding to the reference point: the higher the confidence level of the fine alignment is, the greater the weight is; (3) the weight is assigned according to difficulty of movement of the tooth corresponding to the reference point: the easier the movement is to achieve, the greater the weight is; and (4) the weight is assigned according to a position of the reference point on the tooth: the closer the position is to a crown, the greater the weight is.

In some embodiments, the computer-implemented method for aligning three-dimensional digital models of the dentition further includes: calculating a residual of the overall alignment, and calculating a confidence level of the overall alignment based on the residual.

Another aspect of the present application provides a method for finding from multiple three-dimensional digital models of a dentition one three-dimensional digital model of the dentition that is closest to a three-dimensional digital model of the dentition representing a current tooth arrangement of a patient. The multiple three-dimensional digital models of the dentition respectively represent target tooth arrangements at multiple successive treatment steps. The method includes: aligning the three-dimensional digital model of the dentition representing the current tooth arrangement of the patient with each of the multiple three-dimensional digital models of the dentition using the computer-implemented method for aligning three-dimensional digital modes of the dentition; and finding one three-dimensional digital model of the dentition with the highest confidence level as the one three-dimensional digital model of the dentition that is closest to the three-dimensional digital model of the dentition representing the current tooth arrangement of the patient.

### BRIEF DESCRIPTION OF DRAWINGS

The above and other features of the present application will be further described below in conjunction with the accompanying drawings and detailed description thereof. It should be understood that these drawings only illustrate several exemplary embodiments according to the present application and therefore should not be considered to limit the scope of protection of the present application. Unless otherwise indicated, the drawings are not necessarily to scale and similar reference numbers represent similar components.

FIG. 1 is a schematic flowchart of a computer-implemented method for aligning three-dimensional digital models of a dentition according to an embodiment of the present application.

FIG. 2 schematically shows a local coordinate system set for a three-dimensional digital model of a tooth.

FIG. 3 shows examples of determining point pairs on which the fine alignment is based.

FIG. 4 shows an example of overall alignment using SVD method.

FIG. 5 shows an example of overall alignment using NDT method.

### DETAILED DESCRIPTION

The following detailed description makes reference to the accompanying drawings, which form a part of the specification. The exemplary embodiments mentioned in the specification and drawings are for illustrative purposes only and are not intended to limit the scope of protection of the present application. In light of this application, those skilled in the art will appreciate that many other embodiments may be adopted and that various changes may be made to the described embodiments without departing from the spirit and scope of protection of this application. It should be understood that the various aspects of the present application described and illustrated herein may be arranged, replaced, combined, separated and designed in many different configurations, all of which are within the scope of protection of the present application.

One aspect of the present application provides a computer-implemented method for aligning three-dimensional digital models of a dentition.

Another aspect of the present application provides a computer system for aligning three-dimensional digital models of a dentition, which includes a storage device and a processor. The storage device stores a computer program for aligning three-dimensional digital models of a dentition. When the computer program is executed by the processor, the method for aligning three-dimensional digital models of the dentition is performed.

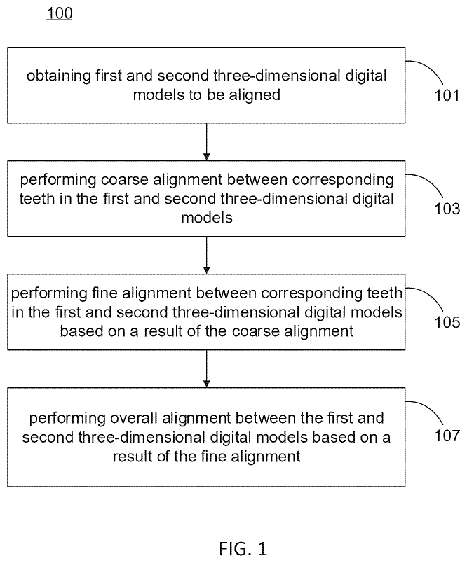

Please refer to FIG. 1, which is a schematic flowchart of a computer-implemented method 100 for aligning three-dimensional digital models of a dentition according to an embodiment of the present application.

In 101, first and second three-dimensional digital models to be aligned are obtained.

As is known to those skilled in the art, orthodontic treatment for a dentition (maxillary or mandibular dentition) using shell-style orthodontic appliances usually requires dozens of successive shell-style orthodontic appliances. Each shell-style orthodontic appliance corresponds to a treatment step and is used to reposition the dentition from the tooth arrangement achieved in the previous treatment step to the target tooth arrangement in the current treatment step.

One application scenario of the method for aligning three-dimensional digital models of a dentition in the present application is as follows. In the process of orthodontic treatment using shell-style orthodontic appliances, alignment is performed between a three-dimensional digital model representing the patient's single dentition at a certain time point and a three-dimensional digital model representing the dentition in a target tooth arrangement at a corresponding treatment step. The treatment effect is evaluated based on the difference between the two three-dimensional digital models after the alignment.

In an embodiment, the first three-dimensional digital model may be a three-dimensional digital model of the patient's current single dentition (maxillary or mandibular dentition) obtained by scanning. For example, in the process of orthodontic treatment, the three-dimensional digital model of the single dentition obtained by scanning when the patient returns for a follow-up visit represents the actual treatment effect achieved by the orthodontic treatment so far.

In an embodiment, the second three-dimensional digital model may be a three-dimensional digital model representing the dentition in a target tooth arrangement at a current treatment step for the patient, or a three-dimensional digital model representing the dentition in a target tooth arrangement at a previous treatment step.

As known to those skilled in the art, in some cases, after wearing the first N successive shell-style orthodontic appliances in sequence, the patient may not have the target tooth arrangement at the Nth treatment step, but may have a tooth arrangement closer to a target tooth arrangement at a treatment step before the Nth treatment step. Therefore, in yet another embodiment, the first three-dimensional digital model may be aligned and compared with the three-dimensional digital models representing the target tooth arrangements at a plurality of successive treatment steps one by one, to find one of the three-dimensional digital models at a treatment step closest to the first three-dimensional digital model. If the difference in the number of steps between the treatment step found and the treatment step finally completed by the patient is too large (for example, greater than a preset step difference threshold), then it can be considered that the actual treatment result has deviated from the original treatment plan, and restarting the treatment can be considered, that is, redesigning the treatment plan based on the patient's current tooth arrangement. In this case, the second three-dimensional digital model may be one of the three-dimensional digital models representing the target tooth arrangements at the plurality of successive treatment steps.

Due to the need for subsequent processing, the first and second three-dimensional digital models are segmented three-dimensional digital models, that is, the teeth thereof are independent of each other.

In 103, each tooth in the first three-dimensional digital model and a corresponding tooth in the second three-dimensional digital model are coarsely aligned.

In an embodiment, the teeth in the first and second three-dimensional digital models are numbered in a predetermined manner. The teeth in the first and second three-dimensional digital models can be paired based on tooth numbers (i.e., the same tooth in the first and second three-dimensional digital models may be found).

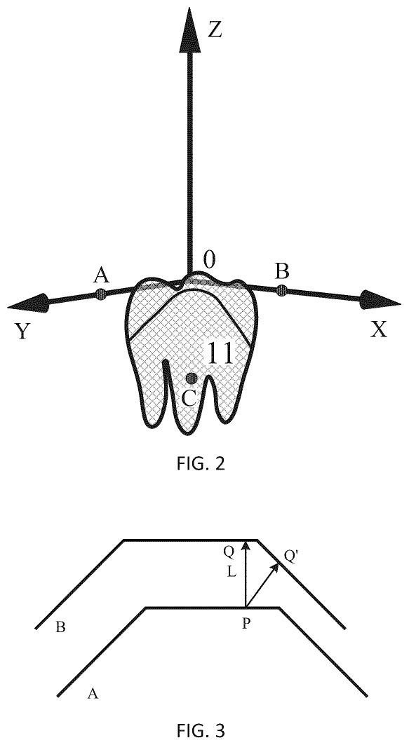

In order to facilitate calculation, in addition to setting a world coordinate system for a three-dimensional digital model of a dentition, a local coordinate system is also set for a three-dimensional digital model of each tooth of the dentition. For example, referring to FIG. 2, the origin O of the local coordinate system is located at the center of the tooth 11. The three axes (X, Y, Z) of the local coordinate system correspond to a long axis of the tooth 11, a mesiodistal direction of the tooth 11, and a labiolingual direction of the tooth 11.

The local coordinate system can be set with extremely high accuracy and consistency using current technologies (e.g., local coordinate system setting methods based on deep learning). Therefore, in an embodiment, two three-dimensional digital models of the same tooth may be coarsely aligned based on the local coordinate system.

In an embodiment, for three-dimensional digital models of the same tooth in the first and second three-dimensional digital models, at least three points in the local coordinate system of the first and second three-dimensional digital models may be selected as reference points. The two three-dimensional digital models of the tooth may be coarsely aligned based on these reference points. For example, four points (0, 0, 0), (1, 0, 0), (0, 1, 0), and (0, 0, 1) may be used as reference points. It can be understood that the selection of reference points is not limited to this example, as long as they are not on the same straight line. For example, as shown in FIG. 2, reference points A, B, and C are three selected reference points with coordinate values (5, 0, 0), (0, 5, 0), and (0, 0,-5).

In some cases, there may be differences between the three-dimensional digital models of the same tooth in the first and second three-dimensional digital models. For example, tooth wear, installation/uninstallation of attachments, or changes in the gum line (for example, which may be caused by the growth of erupted teeth, vertical movement or tilt of teeth, etc.) may cause differences between the three-dimensional digital models of the same tooth scanned at different time points.

If there are significant differences between two three-dimensional digital models of the same tooth, for example, three-dimensional digital models obtained by scanning at different time points during the tooth eruption process may have significant morphological differences, coarse alignment between the two three-dimensional digital models of the same tooth based on the local coordinate system may not work well. In such cases, feature points can be used as reference points for alignment, such as buccal cusp points, facial axis (FA) points, and proximal contact points. At present, there are many methods for identifying feature points on a three-dimensional digital model of a tooth, for example, a feature point identification method based on deep learning. The identification of feature points will not be described in detail here.

In an embodiment, measurements can be made on two three-dimensional digital models of the same tooth, for example, measuring the mesiodistal width and crown height of the tooth. By comparing difference of the measurement results with a preset threshold, it can be determined whether there is a significant difference between the two three-dimensional digital models of the same tooth. If there is a significant difference, the feature points are used as reference points for coarse alignment. Otherwise, coarse alignment can be performed based on the local coordinate system.

In an embodiment, each pair of teeth in the first and second three-dimensional digital models may be coarsely aligned based on the reference points using a Singular Value Decomposition (SVD) method.

In 105, based on the coarse alignment result, each tooth in the first three-dimensional digital model and a corresponding tooth in the second three-dimensional digital model are finely aligned.

After the coarse alignment, each tooth in the first three-dimensional digital model is coarsely aligned with the corresponding tooth in the second three-dimensional digital model. On this basis, the teeth in pairs can be finely aligned.

In an embodiment, an iterative closest point algorithm (hereinafter referred to as ICP algorithm) may be used to finely align two three-dimensional digital models of the same tooth.

In an embodiment, two three-dimensional digital models of the same tooth may be finely aligned based on a point-to-surface approach. For the sake of convenience, the two three-dimensional digital models of the same tooth are respectively referred to as model A and model B below.

In an embodiment, point pairs for the fine alignment may be determined according to the following method. Some vertices sampled or all vertices selected from the model A are taken as a first point set for the fine alignment. For each point in the first point set, a ray is cast from the point along the normal direction. An intersection point of the ray with the model B (i.e., the intersection point of the ray with a surface of the model B) is obtained. The starting point of the ray and the intersection point are taken as a point pair. For example, referring to FIG. 3, for the point P selected on model A, a ray L is cast from the point P along the normal direction perpendicular to the model A. An intersection point Q of the ray L with model B is obtained. {P, Q} is a point pair.

Since the relative positional relationship between model A and model B is unknown, the intersection point of a unidirectional ray with model B may not necessarily be a valid intersection point. Therefore, rays can be cast from a vertex on model A along the normal direction in two opposite directions, or a straight line along the normal direction can be drawn passing through the vertex on model A. In this way, two intersection points with model B may be obtained, and the intersection point closer to the vertex is selected.

In addition, model B may lack a portion which is in model A. Therefore, a threshold can be set. If the distance between a vertex and each corresponding intersection point is greater than the threshold, it is considered that the rays from the vertex along the normal direction have no valid intersection point with model B.

In another embodiment, two three-dimensional digital models of the same tooth may be finely aligned based on a point-to-point approach.

In an embodiment, point pairs for the fine alignment may be determined according to the following method. Some vertices sampled or all vertices selected from model A are taken as a first point set for the fine alignment. For each point in the first point set, a vertex on model B closest to the point is found, and the two vertices are taken as a point pair. For example, referring to FIG. 3, for the point P selected on the model A, a vertex Q′ on the model B closest to the point P is found. {P, Q′} is a point pair.

In an embodiment, a distance threshold may be set. During the iteration process, if the distance of a point pair is less than the distance threshold, the point pair is considered to have completed the alignment. In an embodiment, the distance threshold may be determined according to the accuracy (e.g., 0.1 mm or 0.2 mm) of a scanning device that generates the first and/or second three-dimensional digital models. For example, if the accuracy of the scanning device used is 0.1 mm, then the distance threshold may be set to 0.1 mm, or 0.08 mm, or 0.12 mm, etc.

In an embodiment, a proportion threshold may be set. If the proportion of point pairs that have completed the alignment is greater than the proportion threshold, it is considered that the fine alignment of model A and model B is completed.

In an embodiment, the following conditions can be set. If any one of these conditions is met, the iteration is stopped: (1) the proportion of point pairs that have completed the alignment is greater than the proportion threshold; (2) the number of iterations exceeds a preset iteration number threshold; and (3) the difference between the pose after this iteration and the pose after the previous iteration is less than a preset pose difference threshold (a comprehensive evaluation based on translation and rotation displacements).

Although model A and model B correspond to the same tooth, as mentioned above, due to wear, installation/uninstallation of attachment, and changes in the gum line, model A and model B may not completely overlap. Therefore, it is necessary to minimize the influence of these factors as much as possible during the alignment process.

In an embodiment, at least one of the following methods may be used to assign weights to the points on which the fine alignment is based, so as to minimize the influence of the above factors on the fine alignment.
(1) Weights are assigned according to long axis coordinates of the local coordinate system. A point pair closer to an incisal edge or occlusal surface of the tooth has a higher weight, while a point pair closer to a gum line has a lower weight, so as to minimize the interference caused by the change of the gum line.
(2) Weights are assigned according to point pairs sorted by distance. In each iteration, point pairs are sorted from large to small by distance, and a point pair with a larger distance has a lower weight, so as to minimize interference caused by morphological differences.
(3) Weights are assigned according to a distance threshold. The distance threshold can be set in advance. For example, the distance threshold can be set based on the scanning accuracy. In each iteration, if the distance of a point pair exceeds the distance threshold, it is considered that the distance of the point pair is caused by morphological differences, and a weight of the point pair is reduced. The weight of the point pair can even be reduced to zero, that is, the point pair does not participate in this iteration.

When the iteration of fine alignment stops, the following results are output.
(1) a rigid transformation (translation and rotation in three-dimensional space) between model A and model B.
(2) a confidence level: the proportion of point pairs that have completed the alignment. The higher the proportion, the higher the confidence level, indicating that the alignment result is more reliable and can be used as a reference for subsequent processing.
(3) an anomalous point: a point pair(s) that has/have not completed the alignment when the iteration stops. For example, the distance(s) of the point pair(s) can be compared with the above-mentioned distance threshold, and the point pair(s) with distance(s) greater than the distance threshold is/are regarded as having the morphological difference(s) between model A and model B.

In 107, based on the fine alignment result, the first and second three-dimensional digital models are overall aligned.

In an embodiment, reference points of each tooth in the first three-dimensional digital model can be projected to the corresponding tooth in the second three-dimensional digital model according to the fine alignment result. The first and second three-dimensional digital models can be aligned as a whole (overall aligned) based on the two sets of reference points.

In an embodiment, the reference points of each tooth in the first three-dimensional digital model may follow the reference points selected in the coarse alignment. It is understandable that the reference points may be reselected for each tooth in the first three-dimensional digital model, and the reference points may be reselected using the same method as in the coarse alignment.

One of the purposes of overall aligning the first and second three-dimensional digital models is to determine the pose difference of a tooth displaced between the first and second three-dimensional digital models, and to evaluate the actual treatment effect based on the pose difference. The tooth arrangement actually achieved when completing a treatment step is likely to be different from the target tooth arrangement at the treatment step. In such a case, the first and second three-dimensional digital models cannot completely overlap as a whole. Therefore, the alignment is preferred to focus on the alignment of the stationary teeth to more realistically evaluate the actual treatment effect. Therefore, when performing the overall alignment, in an aspect, a weight can be assigned according to the designed movement amount of each tooth at the treatment step corresponding to the second three-dimensional digital model. The smaller the designed movement amount, the greater the weight.

In another aspect, a weight may be assigned according to the confidence level in the fine alignment result for a single tooth. The higher the confidence level, the greater the weight.

In another aspect, a weight can also be assigned according to the difficulty of tooth movement. For a tooth easy to achieve the movement, after completing a treatment step, the pose of the tooth is closer to the target pose at the treatment step, and thus a greater weight can be assigned to the tooth.

In yet another aspect, weights may be assigned according to the positions of the reference points on the teeth. The closer the reference point is to the crown, the greater the weight.

At least one of the above methods may be used to assign weights to the reference point pairs. After assigning weights to the reference points, overall alignment can be performed based on these reference points.

In an embodiment, an SVD method may be used to perform the overall alignment based on the reference points. The results obtained in the overall alignment include a rigid transformation and a confidence level.

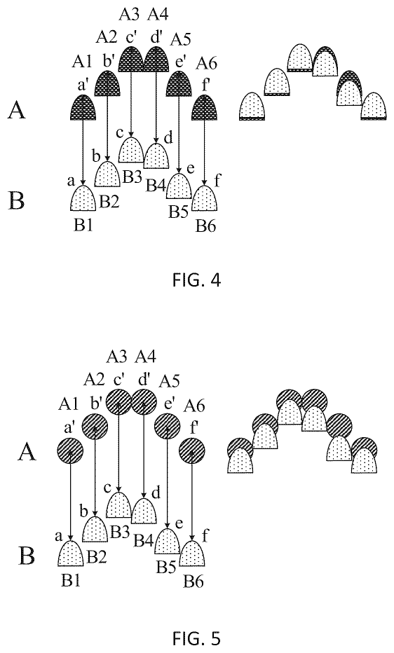

Referring to FIG. 4, on the left, Model A and Model B are shown after each pair of teeth in Model A and Model B has been aligned. In Model A, there are 6 teeth, i.e., tooth A1, tooth A2, tooth A3, tooth A4, tooth A5, and tooth A6. In Model B, there are also 6 teeth, i.e., tooth B1, tooth B2, tooth B3, tooth B4, tooth B5, and tooth B6. Tooth A1 and tooth B1 is one pair of teeth, tooth A2 and tooth B2 is one pair of teeth, tooth A3 and tooth B3 is one pair of teeth, tooth A4 and tooth B4 is one pair of teeth, tooth A5 and tooth B5 is one pair of teeth, and tooth A6 and tooth B6 is one pair of teeth. The 6 pairs of teeth has been coarsely aligned and then finely aligned.

Reference point(s) is/are selected for each tooth in Model A. In FIG. 4, one reference point is selected for one tooth, e.g., reference point a′ for tooth A1, reference point b′ for tooth A2, reference point c′ for tooth A3, reference point d′ for tooth A4 reference point e′ for tooth A5, reference point f′ for tooth A6. Based on a result of the fine alignment, the reference point of each tooth in Model A is projected onto a corresponding tooth in Model B. In FIG. 4, the arrows each represents a corresponding relationship between a pair of reference points. For example, aa′ is a pair of reference point for the pair of teeth B1A1, bb′ is a pair of reference point for the pair of teeth B2A2, cc′ is a pair of reference point for the pair of teeth B3A3, dd′ is a pair of reference point for the pair of teeth B4A4, ee′ is a pair of reference point for the pair of teeth B5A5, ff′ is a pair of reference point for the pair of teeth B6A6.

Based on the above pairs of reference points, and weights assigned to the pairs of reference points, the Model A and Model B are aligned as a whole. The result of the alignment is as shown on the right in FIG. 4.

In an embodiment, the confidence level is based on a residual after the alignment. The larger the residual, the lower the confidence level.

In yet another embodiment, a normal distribution transformation method (NDT for short) may be used to perform the overall alignment based on the reference points.

In an embodiment, for each reference point in the first three-dimensional digital model, a normal distribution model can be established based on its three-dimensional spatial position within a selected treatment step interval (i.e., the treatment step interval where the target tooth arrangement closest to the current tooth arrangement is located, for example, the interval from the current treatment step to several previous treatment steps can be selected) to obtain the mean and covariance matrix of the each reference point.

Next, for each reference point in the second three-dimensional digital model, the distance of the reference point to the normal distribution model (i.e., the Mahalanobis distance) is calculated. The minimum sum of the squares of these distances is calculated, which is the overall alignment result. The results output include a rigid transformation and a confidence level.

Based on Model A and Model B shown on the left in FIG. 4 in which each pair of teeth in Model A and Model B has been aligned, for each reference point (a′, b′, c′, d′, e′, or f′) in Model A, a normal distribution model is established within a selected treatment step interval. See FIG. 5, the circles respectively represent the normal distribution models established for the reference points a′, b′, c′, d′, e′, and f′. The centers of the circles respectively represent the positions with the highest probability of the reference points a′, b′, c′, d′, e′, and f′.

For each reference point (a, b, c, d, e, or f) in Model B, the distance of the reference point to the normal distribution model is calculated. The minimum sum of the squares of these distances is calculated for performing the overall alignment. The result of the alignment is as shown on the right in FIG. 5.

In an embodiment, the sum of the squares of the Mahalanobis distances of the reference points after alignment may be used as a confidence level indicator. The larger the confidence level indicator, the lower the confidence level.

In yet another embodiment, a weight may be assigned to each tooth, and a weighted average transformation may be calculated based on the rigid transformation obtained in the fine alignment, and the average transformation may be used as the overall alignment result of the first and second three-dimensional digital models.

In an embodiment, the weight of each tooth can be set according to at least one of the following: (1) weight is assigned according to the designed movement amount of the tooth (for example, the designed movement amount at a corresponding treatment step, or the total designed movement amount from the original tooth arrangement to a corresponding treatment step), and the smaller the designed movement amount, the greater the weight; (2) weight is assigned according to the confidence level in the fine alignment result for the single tooth, and the higher the confidence level, the greater the weight; (3) weight is assigned according to the difficulty of tooth movement (for example, the movement of a corresponding treatment step, or the movement from the original tooth arrangement to a corresponding treatment step), and the easier the movement is to achieve, the greater the weight.

For each tooth, the difference between the rigid transformation in the fine alignment and the weighted average transformation is calculated. All the differences are summed (taking the absolute value to keep the value non-negative) to obtain the residual of the alignment. The residual of the alignment can be used as an indicator of the confidence level, the higher the residual, the lower the confidence level.

Assume that the first three-dimensional digital model is a three-dimensional digital model of the dentition obtained by scanning after the patient completes the P-th treatment step (i.e., wears the shell-style orthodontic appliance corresponding to the P-th treatment step for a specified period of time). In some cases, the most similar one is not the three-dimensional digital model representing the target tooth arrangement of the dentition at the P-th treatment step, but the three-dimensional digital model representing the target tooth arrangement of the dentition at a treatment step before the P-th treatment step.

In yet another embodiment, three-dimensional digital models may be obtained that respectively represent the target tooth arrangements at the P-th treatment step and a plurality of successive treatment steps within a certain range (e.g., 5 steps or 10 steps) before the P-th treatment step. Using the above method, the first three-dimensional digital model is aligned with each of these three-dimensional digital models. The three-dimensional digital model corresponding to the alignment result with the highest confidence level is taken as the one closest to the first three-dimensional digital model. If the difference between the number of treatment steps corresponding to the three-dimensional digital model and P is too large, it is considered that the treatment has not achieved the expected effect and the treatment plan needs to be redesigned.

Although various aspects and embodiments of the present application are disclosed herein, other aspects and embodiments of the present application will be apparent to those skilled in the art in light of this application. The various aspects and embodiments disclosed herein are for purposes of illustration only and not limitation. The scope and essence of the present application are determined only by the appended claims.

Likewise, the various figures may illustrate exemplary architectures or other configurations of the disclosed methods and systems, which facilitate understanding of features and functionality that may be included in the disclosed methods and systems. What is claimed is not limited to the exemplary architectures or configurations shown, and the desired features may be implemented with a variety of alternative architectures and configurations. In addition, with respect to flow charts, functional descriptions, and method claims, the order of the blocks presented herein should not limit various embodiments to being implemented in the same order to perform the described functionality unless the context clearly dictates otherwise.

Unless expressly stated otherwise, terms and phrases used herein, and variations thereof, should be construed as open ended as opposed to limiting. In some embodiments, the appearance of expansive words and phrases such as “one or more,” “at least,” “but not limited to,” or other similar terms should not be understood as intending or requiring a narrowing in examples where such expansive words may not be present.

1-11. (canceled)

12. A computer-implemented method for aligning three-dimensional digital models of a dentition, comprising:
obtaining first and second three-dimensional digital models, respectively representing the dentition in different tooth arrangements, wherein the first three-dimensional digital model represents the dentition in a current tooth arrangement of a patient, and the second three-dimensional digital model represents the dentition in one of target tooth arrangements at a plurality of successive treatment steps;
performing tooth alignment between each pair of teeth in the first and second three-dimensional digital models; and
performing dentition alignment between the first and second three-dimensional digital models based on a result of the tooth alignment and a weight assigned to the each pair of teeth; wherein the weight is assigned according to at least treatment information of the each pair of teeth at a treatment step corresponding to the second three-dimensional digital model, and a result of the dentition alignment is used for verifying an effect of a tooth treatment at a treatment step corresponding to the first three-dimensional digital model.

13. The computer-implemented method for aligning three-dimensional digital models of the dentition according to claim 12, wherein the weight is assigned to the each pair of teeth according to at least one of following:
the weight is assigned according to a designed movement amount of the each pair of teeth at the treatment step corresponding to the second three-dimensional digital model: the smaller the designed movement amount is, the greater the weight is;
the weight is assigned according to a confidence level of the tooth alignment for the each pair of teeth: the higher the confidence level of the tooth alignment is, the greater the weight is; or
the weight is assigned according to difficulty of movement of the each pair of teeth: the easier the movement is, the greater the weight is.

14. The computer-implemented method for aligning three-dimensional digital models of the dentition according to claim 12, wherein said performing dentition alignment between the first and second three-dimensional digital models comprises:
based on a rigid transformation obtained for the each pair of teeth in the tooth alignment, and the weight assigned for the each pair of teeth, calculating a weighted average transformation; and
based on the weighted average transformation, aligning the first and second three-dimensional digital models.

15. The computer-implemented method for aligning three-dimensional digital models of the dentition according to claim 14, further comprising:
obtaining a difference between the rigid transformation obtained for the each pair of teeth and the weighted average transformation;
calculating a sum of obtained differences to obtain a residual of the dentition alignment; and
determining a confidence level of the dentition alignment based on the residual.

16. The computer-implemented method for aligning three-dimensional digital models of the dentition according to claim 12, wherein said performing dentition alignment between the first and second three-dimensional digital models comprises:
selecting a reference point for each tooth in the first three-dimensional digital model to obtain a first reference point set;
based on the result of the tooth alignment, projecting the reference point of each tooth in the first three-dimensional digital model onto a corresponding tooth in the second three-dimensional digital model to obtain a second reference point set, wherein each reference point in the first reference point set and a corresponding reference point in the second reference point set form a pair of reference points; and
performing dentition alignment between the first and second three-dimensional digital models based on the first and second reference point sets.

17. The computer-implemented method for aligning three-dimensional digital models of the dentition according to claim 16, wherein:
one or more reference points are selected in a local coordinate system of the each tooth; or
one or more feature points of the each tooth are selected as the reference points, wherein the feature points comprises at least one of a combination of: buccal cusp points; facial axis (FA) points; or proximal contact points.

18. The computer-implemented method for aligning three-dimensional digital models of the dentition according to claim 16, wherein said performing dentition alignment between the first and second three-dimensional digital models based on the first and second reference point sets comprises:
based on the first and second reference point sets, and weights assigned to pairs of reference points in the first and second reference point sets, aligning the first and second three-dimensional digital models.

19. The computer-implemented method for aligning three-dimensional digital models of the dentition according to claim 18, wherein a weight is assigned to a pair of reference points according to at least one of following:
the weight is assigned according to a designed movement amount of a tooth corresponding to the reference point at the treatment step corresponding to the second three-dimensional digital model: the smaller the designed movement amount of the tooth is, the greater the weight is;
the weight is assigned according to a confidence level of the tooth alignment for the tooth corresponding to the reference point: the higher the confidence level of the tooth alignment is, the greater the weight is;
the weight is assigned according to difficulty of movement of the tooth corresponding to the reference point: the easier the movement is, the greater the weight is; or
the weight is assigned according to a position of the reference point on the tooth: the closer the position is to a crown, the greater the weight is.

20. The computer-implemented method for aligning three-dimensional digital models of the dentition according to claim 18, wherein said aligning the first and second three-dimensional digital models based on the first and second reference point sets, and weights assigned to pairs of reference points in the first and second reference point sets, comprises:
establishing a normal distribution model within a preset treatment step interval for each reference point in the first reference point set;
obtaining a Mahalanobis distance between each pair of reference points by calculating the Mahalanobis distance of each reference point in the second reference point set to the normal distribution model of a corresponding reference point;
based on the weights assigned to the pairs of reference points in the first and second reference point sets, calculating a weighted sum of squares of the Mahalanobis distances; and
based on the weighted sum of squares of the Mahalanobis distances, aligning the first and second three-dimensional digital models.

21. The computer-implemented method for aligning three-dimensional digital models of the dentition according to claim 16, further comprising:
based on a distance of each pair of reference points in the first and second reference point sets after the dentition alignment, calculating a residual of the dentition alignment; and
calculating a confidence level of the dentition alignment based on the residual.

22. The computer-implemented method for aligning three-dimensional digital models of the dentition according to claim 12, wherein said performing tooth alignment between each pair of teeth in the first and second three-dimensional digital models comprises:
performing coarse alignment between the each pair of teeth in the first and second three-dimensional digital models based on a local coordinate system of the each pair of teeth; and
performing fine alignment between the each pair of teeth after the coarse alignment using an iterative closest point (ICP) method.

23. The computer-implemented method for aligning three-dimensional digital models of the dentition according to claim 22, wherein the coarse alignment is performed between the each pair of teeth by:
selecting a plurality of pairs of reference points in the local coordinate system of the each pair of teeth, each pair of reference points having same coordinate values, and
performing the coarse alignment between the each pair of teeth based on the plurality of pairs of reference points according to a singular value decomposition (SVD) method.

24. The computer-implemented method for aligning three-dimensional digital models of the dentition according to claim 22, wherein weights of point pairs on which the fine alignment is based are assigned according to at least one of following:
weights are assigned according to long axis coordinates of the local coordinate system: a point pair closer to an incisal edge or occlusal surface of a tooth has a higher weight, and a point pair closer to a gum line has a lower weight;
weights are assigned according to the point pairs sorted by distance: in each iteration of the ICP method, the point pairs are sorted from large to small by distance, and a point pair with a larger distance has a lower weight; or
weights are assigned according to a preset distance threshold: in each iteration of the ICP method, based on that a distance of a point pair exceeds the preset distance threshold, a weight of the point pair is reduced.

25. The computer-implemented method for aligning three-dimensional digital models of the dentition according to claim 22, further comprising:
calculating a confidence level of the fine alignment based on a proportion of point pairs that complete the fine alignment.

26. The computer-implemented method for aligning three-dimensional digital models of the dentition according to claim 22, wherein in each of point pairs on which the fine alignment is based for the each pair of teeth, a first point is a vertex of a first tooth in the pair of teeth, and a second point is an intersection point of a ray from the first point along a normal direction and a surface of a second tooth in the pair of teeth.

27. A method for finding from multiple three-dimensional digital models of a dentition one three-dimensional digital model of the dentition that is closest to a three-dimensional digital model of the dentition representing a current tooth arrangement of a patient, wherein the multiple three-dimensional digital models of the dentition respectively represent target tooth arrangements at multiple successive treatment steps, and the method comprises:
aligning the three-dimensional digital model of the dentition representing the current tooth arrangement of the patient with each of the multiple three-dimensional digital models of the dentition using the computer-implemented method according to claim 12; and
finding the one three-dimensional digital model of the dentition that is closest to the three-dimensional digital model of the dentition representing the current tooth arrangement of the patient according to results of the aligning for the multiple three-dimensional digital models of the dentition.

28. The method for finding from multiple three-dimensional digital models of the dentition one three-dimensional digital model of the dentition that is closest to the three-dimensional digital model of the dentition representing the current tooth arrangement of the patient according to claim 27, wherein the results of the aligning comprise confidence levels of the aligning, and wherein said finding the one three-dimensional digital model of the dentition that is closest to the three-dimensional digital model of the dentition representing the current tooth arrangement of the patient according to results of dentition alignments for the multiple three-dimensional digital models of the dentition comprises:
finding one three-dimensional digital model of the dentition with the highest confidence level of the aligning as the one three-dimensional digital model of the dentition that is closest to the three-dimensional digital model of the dentition representing the current tooth arrangement of the patient.

29. A method for verifying an effect of a tooth treatment, comprising:
finding the one three-dimensional digital model of the dentition that is closest to the three-dimensional digital model of the dentition representing the current tooth arrangement of the patient according to the method in claim 27;
determining a step difference between a treatment step corresponding to the one three-dimensional digital model of the dentition and a treatment step corresponding to the three-dimensional digital model of the dentition representing the current tooth arrangement of the patient;
verifying the effect of the tooth treatment at the treatment step corresponding to the three-dimensional digital model of the dentition representing the current tooth arrangement of the patient based on the step difference.

30. The method for verifying the effect of the tooth treatment according to claim 29, further comprising:
based on the step difference is less than a threshold, determining the effect of the tooth treatment meets an expected effect;
based on the step difference is not less than the threshold, determining the effect of the tooth treatment does not meet the expected effect.

31. The method for verifying the effect of the tooth treatment according to claim 29, further comprising:
based on the effect of the tooth treatment does not meet the expected effect, redesigning a treatment plan based on the current tooth arrangement of the patient.
